(19) United States
(12) Patent Application Publication
(10) Pub. No.: US 2023/0149255 A1
(43) Pub. Date: May 18, 2023

(54) ADULT SEXUAL ENHANCEMENT DEVICE

(71) Applicant: Richard Anthony Wright, II, Fort Hood, TX (US)

(72) Inventor: Richard Anthony Wright, II, Fort Hood, TX (US)

(21) Appl. No.: 18/100,221

(22) Filed: Jan. 23, 2023

(51) Int. Cl. A61H 19/00

(52) U.S. Cl. CPC A61H 19/50; A61H 2201/165; A61H 2201/123

(57) ABSTRACT

Presented is a hands-free adult sexual enhancement device and method to enhance sexual pleasure in females and males by stimulating female and male erogenous zones before or during the sexual intercourse without interfering the sexual intercourse.

### TECHNICAL FIELD OF INVENTION

The present invention relates to the field of sexual enhancement devices or adult vibrator devices, particularly, the present invention relates to an adult sexual enhancement device and associated method of use to enhance sexual pleasure in females and males by stimulating female and male erogenous zones before or during the sexual intercourse without interfering the sexual intercourse.

### BACKGROUND

Stimulating female and male erogenous zones (such as for example, clitoris, nipples, neck, ears, inner arms, armpits, naval, testicles, perineum, and lower stomach plays an important role in a female's and male's sexual arousal and satisfaction. Sexual arousal results in more passionate and satisfying sex between couples.

Men and women both enjoy the constant stimulation of their various erogenous zones during sexual intercourse. Providing a constant stimulation to erogenous zones in men and women is often awkward, uncomfortable, or inconvenient. Various types of vibrator devices are made available by different inventors in the past, however, they are either useful to stimulate some specific body parts/erogenous zones such as clitoris in females, or aren't directly attached to the body or may include mounting/attachment devices that are weaker in nature to adhere to the body surface or that interfere with sexual enjoyment or potentially cause pain or injury. They fail to provide a hands-free operation of the device and often users end up not receiving complete sexual pleasure. Some of such devices are found disclosed in U.S. Pat. Nos. 6,056,705, 6,179,775, and 6,991,598.

Some externally worn hands-free devices are also known in the art which are powered by AA cells or larger batteries. Such devices are held in proximity to the genital area with a special harness generally appearing like an athletic supporter and consist of a waistband or belt, a fabric pouch at the front, and two straps which attach to the pouch, pass through the legs, and attach at the rear of the waistband. However, the use of such devices is quite cumbersome and less user-friendly.

In the light of the foregoing, the inventor herein proposes a simple and yet more reliable solution that is considerate in terms of its size, weight, and importantly adaptability to be used in different female and male erogenous zones (making it a universal device), and yet reliable to constantly simulate the erogenous zones where it is applied to without interfering with the sexual intercourse in couples.

### SUMMARY

It is an object of the present invention to provide a miniature hands-free device that is attachable to female and male erogenous zones of the body and when operated simulates the corresponding erogenous zones to enhance sexual pleasure among the males and females before or during their sexual intercourse.

It is an object of the present invention to provide an adult sexual enhancement device that is easy to apply and reliably attaches to males or females' erogenous zones of the body and is sized and shaped to encompass a number of female and male erogenous zones such as but not limited to clitoris, nipples, neck, ears, inner arms, armpits, naval, testicles, perineum, and lower stomach.

It is an object of the present invention to provide an adult sexual enhancement device that, by way of vibratory action stimulates erogenous zones in males and females that can lead a woman or a man to particular states of excitement before or during sexual intercourse.

It is another object of the present invention to provide an adult sexual enhancement device that can lead a woman to orgasm or helps the woman maintain orgasm for a longer period of time during sexual intercourse especially if the woman has reduced sensitivity to sexual stimulation (for example due to aging).

In accordance with one or more embodiments, the present invention provides an adult sexual enhancement device. The device includes a casing to encapsulate at least one linear resonant drive motor for producing vibratory back-and-forth motion along a single axis (Z axis) at its resonant frequency when it receives a drive signal from at least one controller (108); at least one switch to perform at least one of: turning on/off the passage of the drive signal from the at least one controller to the at least one linear resonant drive motor, and changing intensity levels of the vibratory motion produced by the at least one linear resonant drive motor; a power source to power the device; and a charging port to charge the power source.

In accordance with one or more embodiments, the casing comprises a top surface, a bottom surface, and a plurality of intermediate side wall portions connecting the top surface to the bottom surface to enclose the at least one linear resonant drive motor, the at least one switch, the power source, and the charging port therein. A first intermediate side wall portion and a second intermediate side wall portion of the plurality of intermediate side wall portions are outwardly concave and wherein the second intermediate side wall portion providing an interface to allow accessibility of the charging port to a male or female for charging the device.

In accordance with one or more embodiments, the adult sexual enhancement device further includes a pair of attaching members, each of the pair of attaching members detachably attaches to the first intermediate side wall portion and the second intermediate side wall portion for detachably affixing the device to a female's or male's erogenous zone to provide a stimulation thereon before or during the sexual intercourse without interfering the sexual intercourse.

These and other features and advantages along with other embodiments of the present invention will become apparent from the detailed description below, in light of the accompanying drawings.

### BRIEF DESCRIPTION OF DRAWINGS

In the drawings:

FIG.1 illustrates a front perspective view of an adult sexual enhancement device of the present invention in a fully assembled configuration, according to an exemplary embodiment of the present invention.

FIG.2A illustrates a front perspective view of the adult sexual enhancement device of FIG.1 with attaching members being slidably attached to the casing of the device, according to an exemplary embodiment of the present invention.

FIG.2B illustrates an exploded side view of the adult sexual enhancement device of FIG.1.

FIG.3 illustrates a front view of the adult sexual enhancement device of FIG.1 without the attaching members, according to an exemplary embodiment of the present invention.

FIG.4 illustrates an end view of the adult sexual enhancement device of FIG.3.

FIGS.5 and 6 illustrate a front perspective view and a back perspective view of a hardware architecture of the adult sexual enhancement device of FIG.3 made visible by removing a casing that would otherwise embody the hardware architecture, according to an exemplary embodiment of the present invention.

FIG.7 shows a representative block diagram of electronics encapsulated within the casing of the adult sexual enhancement device of FIG.3, according to an exemplary embodiment.

FIGS. 8 and 9 show attachment of the adult sexual enhancement device of FIG.1 to different erogenous zones in a female, according to various exemplary embodiments.

### DETAILED DESCRIPTION

Some embodiments, illustrating its features, will now be discussed in detail. The words “comprising,” “having,” “containing,” “including,” “consisting,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments in description and drawings are merely exemplary.

References to “one embodiment”, “an embodiment”, “another embodiment”, “an example”, “another example”, “some embodiment”, “yet another embodiment”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. Unless stated otherwise, terms such as “first”, “second”, “third”, are used to arbitrarily distinguish between the elements such terms describe. Thus, these terms are not necessarily intended to indicate temporal or other prioritization of such elements.

Before describing the present invention in detail, it should be observed that the present invention relates to an adult sexual enhancement device and associated method of use to enhance sexual pleasure in females and males. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting but as a representative basis for teaching one skilled in the art to variously employ the present invention in virtually any appropriately detailed structure. Further, the terms and phrases used herein are not intended to be limiting but rather to provide an understandable description of the invention.

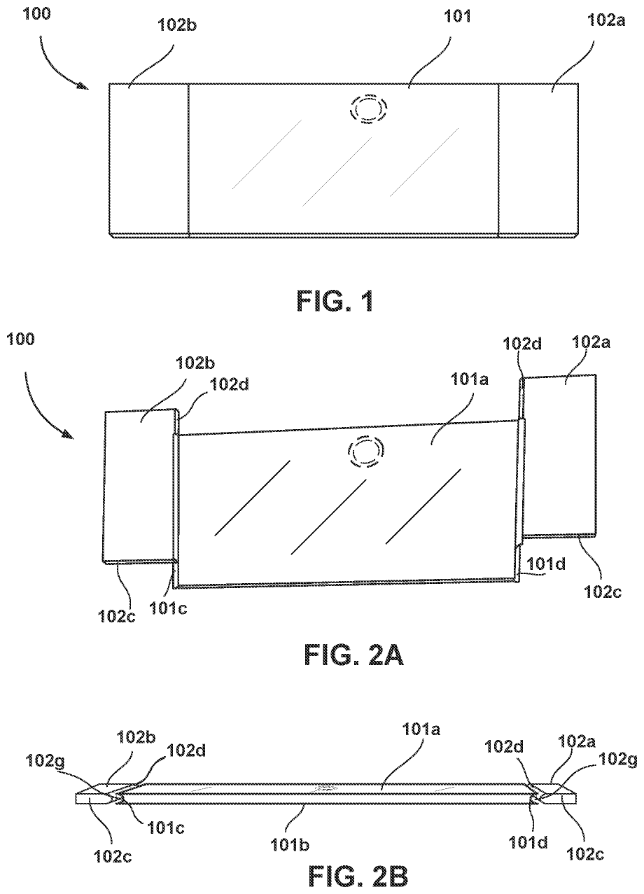

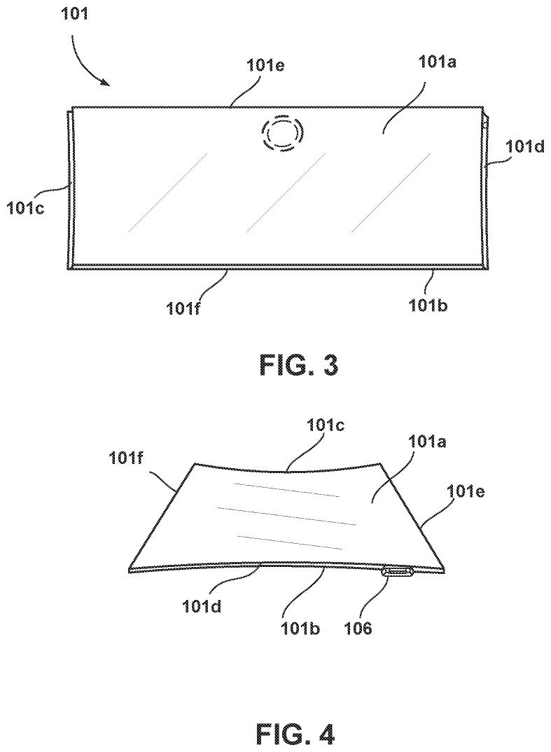

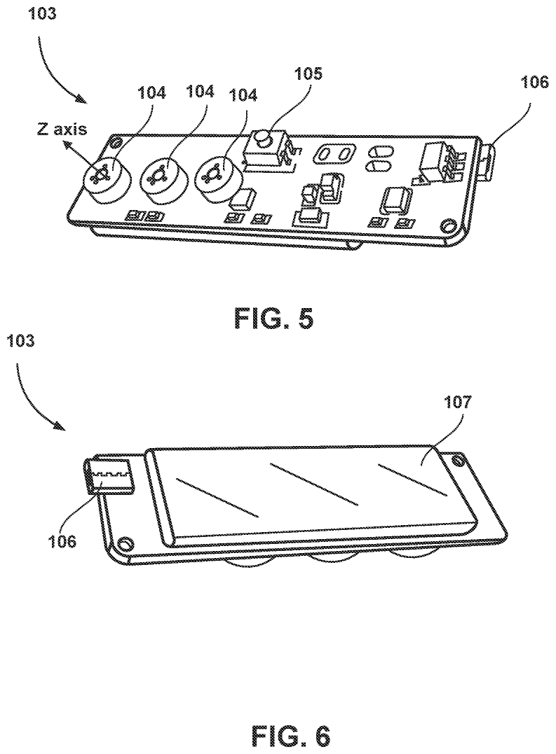

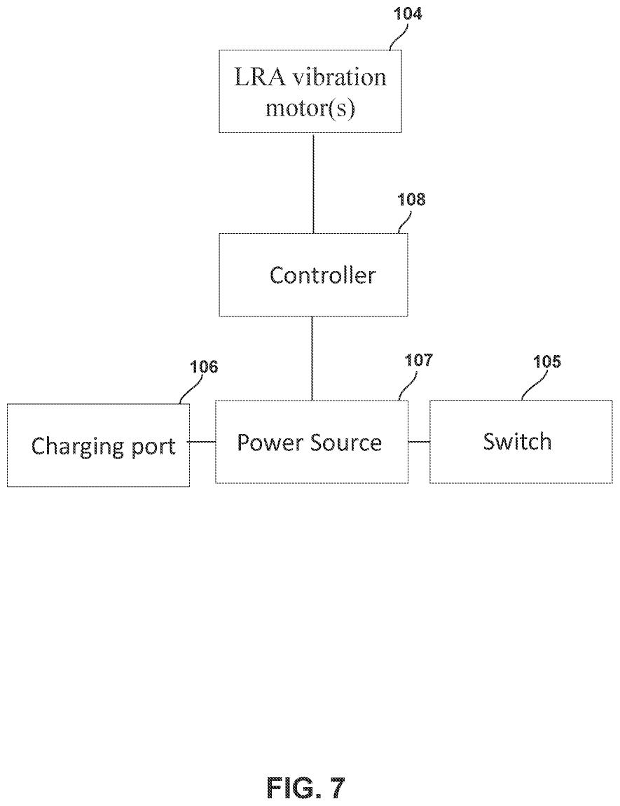

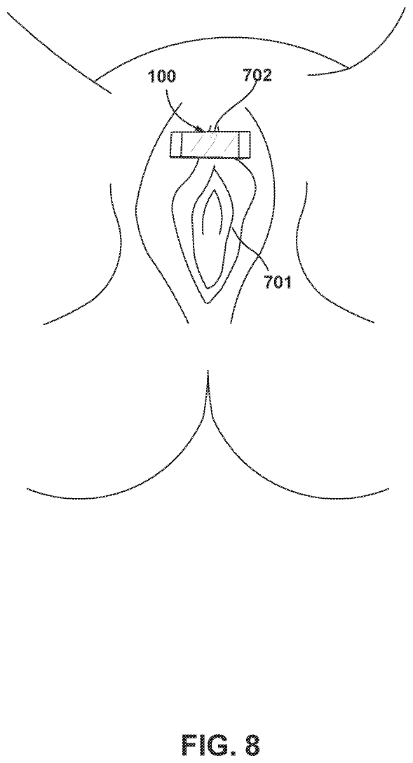

The various features and embodiments of an adult sexual enhancement device and associated method of use to enhance sexual pleasure in females and males of the present invention are better explained in conjunction with FIGS. 1-9.

Referring to the accompanying figures, particularly FIGS.1-7, the adult sexual enhancement device 100 (hereinafter referred to as “device 100”) of the present invention includes a casing 101. The casing 101 includes a top surface 101a, a bottom surface 101b, and intermediate side wall portions 101c-101f connecting the top surface 101a to the bottom surface 101b. There are four intermediate side wall portions 101c-101f connecting the top surface 101a to the bottom surface 101b. Also, as seen, a first intermediate side wall portion 101c and a second intermediate side wall portion 101d of the intermediate side wall portions (101c-101f) are made outwardly concave (in a substantially curved shape) forming a groove for ease of detachably/removably connecting attaching members 102a,102b to the casing 101. The intermediate side wall portions 101c, 101d comprise silicon deposits to make them rigid. The casing 101 is preferably made using silicon material, or other resilient material or any other suitable material that's user skin friendly. The casing 101 is suitably sized to enclose all the components of the device 100 there inside. In an example embodiment, the casing 101 is 40 mm in length and 20 mm in width. The casing 101 enclosing the different components is intended to be reusable.

The casing 101 encapsulates or encases different components of device 100. In particular, the casing 101 is configured is enclose or encase at least one linear resonant drive motor 104. In an example, three such motors 104 are shown configured on a PCB circuitry 103. It should be understood that any other number of such motors 104 may be used depending on the vibrating intensity desired from the device 100. In a preferred embodiment, the linear resonant drive motor 104 is a linear resonant actuator (LRA) vibration motor. When operated with appropriate voltage and current, the linear resonant drive motor 104 produces vibratory back-and-forth motion along a single axis (Z axis) at its resonant frequency. The linear resonant drive motor 104 may operate at the resonant frequency in the range of 100-255 Hz. To keep the device 100 sizes minimal or miniatured, one may choose smaller sizes of the LRA vibration motor 104. For example, the size of the motor 104 may be 10 mm in length, 10 mm in width, and 4 mm in height. In another example, the size of the LRA motor 104 may be 12 mm in length, 4 mm in width, and 3.5 mm in height. In another example, the LRA motor 104 maybe 8 mm in diameter and 2.5 mm in thickness. The LRA motor 104 typically includes a case and a bracket, the case, and bracket enclose one or more magnets, spring, weight, coil, yoke, and porons. The detailed assembly of the LRA motor 104 is omitted from the description considering the same is known to a person skilled in the art.

The casing 101 further encapsulates or encases at least one switch 105. The switch 105 may be an electrical switch according to one embodiment. The switch 105 may be a mechanical switch according to another embodiment. The switch 105 may be used by a user (male user or female user) to turn on/off the device 100. Basically, the switch 105 may be operated by the user to cut off or establish the passage of the drive signal from the at least one controller 108 to the resonant drive motor 104. The switch 105 may also be operated for adjusting intensity levels of the vibratory motion produced by the linear resonant drive motor 104. In one embodiment, there may be provided a single switch 105 to perform these functions or there may be provided multiple switches for dedicated operation (for example, one switch may be used for turning off/on, another switch may be used for minimizing vibratory motion of the motor 104, another switch may be used for increasing vibratory motion.

The casing 101 further encapsulates or encases a power source 107 used for powering the device 100. The power source 107 is a battery. The battery may be a Li-ion battery or other similar battery type.

The casing 101 further encapsulates or encases a charging port 106 used for allowing the user to charge the power source 107. In an embodiment, the charging port 106 is a USB type C charging port. In some other embodiment, the charging port 106 is USB Type-A or USB Type-B charging port. According to an embodiment, the second intermediate side wall portion 101d of the casing 101 provides an interface or opening through which the charging port 106 is made accessible to the user. The accessibility allows charging of the device 100 (or the power source 107) when the device 100 goes down with power.

Referring to FIGS.1 and 2, the device 100 is provided with a pair of attaching members 102a,g with the grooves 102g of the intermediate side wall portions 101c and 101d. According to the embodiment, the attaching members 102a, and 102b are silicon adhesive tapes with a peelable layer 102c underside. An end of these attaching members 102a, and 102b are silicon molded to slidably fit within the grooves 102g. The width of the attaching members 102a, and 102b are substantially the same as that of the casing 101. In another embodiment, the width of the attaching members 102a, and 102b may be less than the width of the casing 101. The attaching members 102a, and 102b are configured in a way that they can be easily detached and removed from grooves of the casing 101 for ensuring better hygiene. In an embodiment, each of the pair of attaching members 102a,102b is 20 mm in length and 20 mm in width

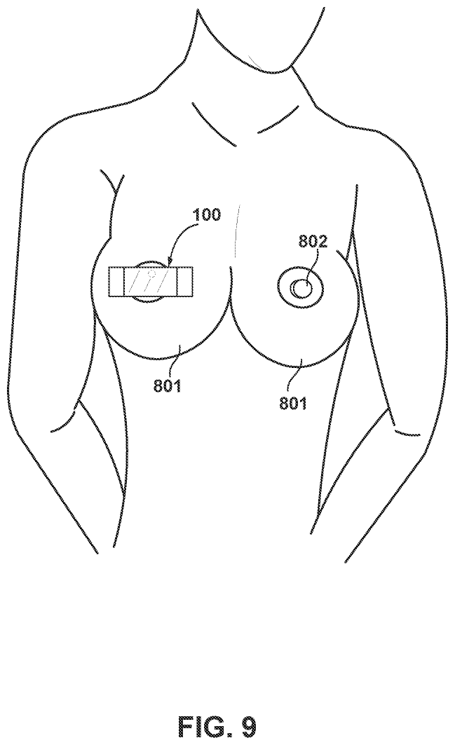

In operation, as may be interpreted from FIGS. 8 and 9 in conjunction with FIGS.1 and 2, the provided device 100 (as described above) is held by a male or female user either prior to or during sexual intercourse. Next, peelable layers 102c of each of the pair of attaching members 102a, and 102b are peeled off by the user. Next, the bottom surface 101b of the casing 101 is aligned and placed in contact with the male or female erogenous zone 702,802 (702 particularly shows the clitoris in a female, and 802 shows nipple on the breasts in a female) disposing of the attaching members 102a,102b on either side of the male's and female's erogenous zones 702,802. Applying pressure on the attaching members 102a, 102b the device 100 get adhered to the skin of the user. Next, the user may operate the at least one switch 105 to turn on/off the device 100 depending upon the requirement. The user is also facilitated to adjust the intensity levels of a vibratory motion (using the switch 105) produced by the linear resonant drive motor(s) (104) to stimulate the erogenous zones 702,802.

Although particular embodiments of the invention have been described in detail for purposes of illustration, various modifications and enhancements may be made without departing from the spirit and scope of the invention.

Claims

What is claimed is:

1. An adult sexual enhancement device (100), comprising:
(a) a casing (101) to encapsulate
at least one linear resonant drive motor (104) for producing vibratory back-and-forth motion along a single axis (Z axis) at its resonant frequency when it receives a drive signal from at least one controller (108);
at least one switch (105) to perform at least one of: turning on/off the passage of the drive signal from the at least one controller (108) to the at least one linear resonant drive motor (104), and changing intensity levels of the vibratory motion produced by the at least one linear resonant drive motor (104);
a power source (107) to power the device (100); and
a charging port (106) to charge the power source (107);
wherein, the casing (101) comprises a top surface (101a), a bottom surface (101b), and a plurality of intermediate side wall portions (101c-101f) connecting the top surface (101a) to the bottom surface (101b) to enclose the at least one linear resonant drive motor (104), the at least one switch (105), the power source (107) and the charging port (106) therein;
wherein, a first intermediate side wall portion (101c) and a second intermediate side wall portion (101d) of the plurality of intermediate side wall portions (101c-101f) are made outwardly concave comprising a groove 102g and wherein the second intermediate side wall portion (101d) providing an interface to allow accessibility of the charging port (106) to a male or female for charging the device (100); and
(b) a pair of attaching members (102a,102b), each of the pair of attaching members (102a,102b) detachably attaches to the first intermediate side wall portion (101c) and the second intermediate side wall portion (101d) for detachably affixing the device (100) to a female's or male's erogenous zone (702,802) to provide a stimulation thereon before or during the sexual intercourse without interfering the sexual intercourse.

2. The adult sexual enhancement device (100) of claim 1, wherein the at least one linear resonant drive motor (104) is a linear resonant actuator (LRA) vibration motor.

3. The adult sexual enhancement device (100) of claim 1, wherein the power source (107) is a battery.

4. The adult sexual enhancement device (100) of claim 1, wherein the charging port (106) is USB type C charging port.

5. The adult sexual enhancement device (100) of claim 1, wherein the charging port (106) is USB Type-A or USB Type-B charging port.

6. The adult sexual enhancement device (100) of claim 1, wherein the at least one switch (105) is an electrical switch or a mechanical switch.

7. The adult sexual enhancement device (100) of claim 1, wherein the at least one linear resonant drive motor (104) operating at the resonant frequency in the range of 100-255 Hz.

8. The adult sexual enhancement device (100) of claim 1, wherein the casing (101) is configured at least in the form of a pouch, a sleeve, or a box to securely hold the at least one linear resonant drive motor (104), the at least one switch (105), the power source (107) and the charging port (106) therein.

9. The adult sexual enhancement device (100) of claim 1, wherein the casing (101) is 40 mm in length and 20 mm in width.

10. The adult sexual enhancement device (100) of claim 1, wherein the casing (101) is made using silicon.

11. The adult sexual enhancement device (100) of claim 1, wherein each of the pair of attaching members (102a,102b) is configurable to get disposed of on either side of the male's and female's erogenous zone (702,802) to approximately dispose of the device (100) in contact with the erogenous zone (702,802).

12. The adult sexual enhancement device (100) of claim 1, wherein the pair of attaching members (102a,102b) are silicon adhesive tapes with an end of each of the pair of attaching members (102a,102b) is silicon molded in a convex shape.

13. The adult sexual enhancement device (100) of claim 1, wherein the pair of attaching members (102a,102b) are disposable after each use, and the casing (101) with enclosed components within the casing (101) is reusable.

14. The adult sexual enhancement device (100) of claim 1, wherein each of the pair of attaching members (102a,102b) is 20 mm in length and 20 mm in width.

15. The adult sexual enhancement device (100) of claim 1, wherein each of the attaching members 102a, and 102b comprises a curved profile or convex profile 102d at one end that removably attaches to the outwardly concave intermediate side wall portions 101c and 101d.

16. A method for stimulating female's or male's erogenous zones (702,802), comprising:
providing an adult sexual enhancement device (100) affixable on the female's or male's erogenous zones (702,802), wherein the device (100) comprising a casing (101) having a top surface (101a), a bottom surface (101b), and a plurality of intermediate side wall portions (101c-101f) connecting the top surface (101a) to the bottom surface (101b), the casing (101) configured to enclose at least one linear resonant drive motor (104), which when operated, produces vibratory back-and-forth motion along a single axis (Z axis) at its resonant frequency; at least one switch (105); a power source (107) to power the device (100); and a charging port (106) to charge the power source (107);
providing a pair of attaching members (102a,102b), each of the pair of attaching members (102a,102b) detachably attaches to the first intermediate side wall portion (101c) and the second intermediate side wall portion (101d) for detachably affixing the device (100) to the female's or male's erogenous zones (702,802) to provide a stimulation thereon before or during the sexual intercourse without interfering the sexual intercourse, wherein the first intermediate side wall portion (101c) and a second intermediate side wall portion (101d) of the plurality of intermediate side wall portions (101c-101f) are made outwardly concave comprising a groove 102g;
removing a peelable layer (102c) of each of the pair of attaching members (102a,102b) to dispose of the pair of attaching members (102a,102b) on either side of the male's and female's erogenous zones (702,802) to approximately dispose of the bottom surface (101b) of the device (100) in contact with the erogenous zone (702,802);
and operating the at least one switch (105) to turn on/off the device (100), and adjust intensity levels of a vibratory motion produced by the at least one linear resonant drive motor (104) to stimulate the female's or male's erogenous zones (702,802).

17. The method for stimulating female's or male's erogenous zones (702,802) of claim 16, wherein the second intermediate side wall portion (101d) providing an interface to allow accessibility of the charging port (106) to a male or female for charging the device (100).

18. The method for stimulating female's or male's erogenous zones (702,802) of claim 16, wherein the at least one linear resonant drive motor (104) is a linear resonant actuator (LRA) vibration motor.

19. The adult sexual enhancement device (100) of claim 16, wherein each of the attaching members 102a, and 102b comprises a curved profile or convex profile 102d at one end that removably slides within the groove 102g of each of the outwardly concave intermediate side wall portions 101c and 101d.
